(19) United States
(12) Patent Application Publication
(10) Pub. No.: US 2026/0036741 A1
(43) Pub. Date: Feb. 5, 2026

(54) Polarization-Maintaining Multi-Core Optical Fiber

(71) Applicants: Friedrich-Schiller-Universität Jena, Jena (DE); GSI Helmholtzzentrum für Schwerionenforschung GmbH, Darmstadt (DE); Fraunhofer-Gesellschaft zur Förderung der angewandten Forschung e. V., München (DE)

(72) Inventors: Thomas Schreiber, Jena (DE); Albrecht Steinkopff, Jena (DE); Arno Klenke, Jena (DE); Nicoletta Haarlammert, Jena (DE); César Jauregui Misas, Dornburg-Camburg (DE); Christopher Aleshire, Jena (DE); Jens Limpert, Jena (DE); Johannes Nold, Jena (DE)

(73) Assignees: Friedrich-Schiller-Universität Jena, Jena (DE); GSI Helmholtzzentrum für Schwerionenforschung GmbH, Darmstadt (DE); Fraunhofer-Gesellschaft zur Förderung der angewandten Forschung e. V., München (DE)

(21) Appl. No.: 19/150,050

(22) PCT Filed: Jan. 25, 2024
(86) PCT No.: PCT/EP2024/051722

§ 371 Date: Jul. 22, 2025

(30) Foreign Application Priority Data
Jan. 27, 2023 (DE) 102023102052.8

(51) Int. Cl. G02B 6/024; G02B 6/02; H01S 3/067

(52) U.S. Cl. CPC G02B 6/024; G02B 6/02042; G02B 6/02338; G02B 6/02342; H01S 3/06712; H01S 3/06737

(57) ABSTRACT

The disclosure relates to an optical fiber having multiple light-conducting core regions which extend, mutually spaced, along the longitudinal extension of the optical fiber. In a cross-sectional view, each light-conducting core region is located inside a contiguous signal region which is completely enclosed by a cladding region. Outside the signal region, stress elements of the optical fiber are designed to generate a mechanical stress field in the optical fiber. The stress elements subject each core region to a mechanical stress causing birefringence, and thus polarization-maintaining behavior. One main polarization axis is assigned with each of the core regions. The stress elements may be distributed in groups of two or more stress elements across the cross-section of the optical fiber. In a cross-sectional view, the stress elements have an asymmetrical, namely non-rotationally symmetrical arrangement, which causes the main polarization axes to point in the same direction in all core regions.

### CROSS-REFERENCE TO RELATED APPLICATIONS

This application is a national phase entry of International Patent Application No. PCT/EP2024/051722, filed Jan. 25, 2024, which claims priority to German Patent Application No. DE102023102052.8, filed Jan. 27, 2023, the content of each being incorporated herein by reference in its entirety for all purposes.

### TECHNICAL FIELD

The present disclosure relates to an optical fiber having a plurality of light-conducting core regions which extend, mutually spaced, along the longitudinal extension of the optical fiber and which are all located, viewed in the cross-section of the optical fiber, inside a contiguous signal region which, for its part, is completely enclosed by a cladding region, wherein the optical fiber contains stress elements which are designed to generate a mechanical stress field in the optical fiber, wherein each core region is subjected by the stress elements to a mechanical stress causing birefringence and thus polarization-maintaining behavior, wherein one main polarization axis is assigned with each of the core regions.

The present disclosure also relates to a laser system that uses such an optical fiber.

### BACKGROUND

Optical fibers are known in various configurations from the prior art. Optical fibers are lines for transmitting light. The best-known optical fibers are dielectric fibers, which are made up of concentric layers. In the center of the cross-section is a light-conducting core area, which is surrounded by a cladding region that has a lower refractive index than the core area. In commercial fiber optic cables, protective layers of plastic surrounding the cladding region are also provided. Depending on the application, the core area has a diameter of a few micrometers to over one millimeter. A distinction is made between optical fibers according to the number of modes of electromagnetic radiation capable of propagation, which is limited by the core diameter (single-mode/multimode fibers).

The further development of fiber lasers in recent times has led to optical fibers as an active medium (with a laser-active core area) providing a reliable concept for high-power lasers. The development from low-energy lasers to high-power lasers for industrial applications is based on the ability of optical fibers to handle high power. The very good ratio of surface area to active volume allows heat to be dissipated efficiently. This is an excellent prerequisite for high-power operation. However, the restriction of the light signal to the core area of the optical fiber leads to high light intensity and to interactions between the material of the optical fiber and the light signal. For example, this results in non-linear effects that are difficult to control. This severely impairs the signal quality.

Optical fibers should therefore be designed in such a way that non-linear effects and interactions with the fiber material are reduced.

From the WO 2016/050898 A1 an optical fiber is known with a plurality of light-conducting core areas that are spaced apart from one another along the length of the optical fiber and that are enclosed by a common cladding region when viewed in the cross-section of the optical fiber. The previously known optical fiber is used as an optical amplifier in a laser system in which a laser beam from a laser source is split into at least two spatially separated partial beams by means of a splitting element. The partial beams then propagate through the optical fiber, with the core areas each guiding a partial beam. A combination element is provided that coherently superimposes the partial beams after propagation through the optical fiber to form an output beam. The individual partial beams are amplified in parallel in the optical fiber, for which purpose the core areas are doped with rare earth ions. These are optically pumped by means of pump radiation guided in the common cladding region. The previously known approach is based on reducing non-linear effects and interactions with the fiber material by amplifying the individual partial beams at a correspondingly reduced intensity. The desired overall performance is only achieved by the coherent superposition of the partial beams in the output beam.

From the EP 3 163 339 A1, a polarization-maintaining (PM) multicore fiber is known that is based on the integration of stress elements in the spaces between the core regions, so that the stress elements act on individual core regions and expose them to a mechanical stress field that generates birefringence. This is problematic for high-power fiber laser systems, as the arrangement of the stress elements leads to a loss of pump absorption. In addition, the stress elements in this arrangement are significantly larger than the cores. This also leads to an impairment of the pump absorption and is therefore undesirable. The stress elements can, for example, be made of a material that differs from the material of the optical fiber surrounding the stress elements in terms of its coefficient of thermal expansion. This results in the desired mechanical stresses when the optical fiber cools down after drawing.

In principle, polarization maintenance can also be achieved with cores that are not circular in cross-section (shape birefringence). However, this is also not desirable for high-power fiber lasers due to the asymmetry of the emitted beam.

WO 2014/132793 A1 describes a multicore fiber with a cladding and a large number of light-conducting core elements provided within the cladding. Each core element has an inner cladding layer which surrounds the actual core. An outer cladding layer is provided which surrounds the inner cladding layer and has an average refractive index which is lower than that of the cladding and the inner cladding layer. A plurality of stress elements is provided within the cladding. The stress elements are arranged in such a way that the effective refractive index for polarized waves of the same linearly polarized (LP) mode is reduced in the light propagating through the core elements.

### SUMMARY

The present disclosure relates to an optical fiber of the type described above in that all stress elements are located outside the signal range, whereby the mechanical stress field generated by the arrangement of the stress elements causes the main polarization axes to point in the same direction in all core regions.

### BRIEF DESCRIPTION OF THE DRAWINGS

Aspects of the present disclosure are explained in more detail below with reference to the drawings showing exemplary embodiments. In the drawings:

FIG. 1 is a schematic, cross-sectional representation of a first variant of an optical fiber according to aspects of the present disclosure;

FIG. 2 is a schematic, cross-sectional representation of a second variant of an optical fiber according to aspects of the present disclosure;

FIG. 3 is a schematic, cross-sectional representation of a third variant of an optical fiber according to aspects of the present disclosure;

FIG. 4 is a schematic, cross-sectional representation of a fourth variant of an optical fiber according to aspects of the present disclosure;

FIG. 5 is a schematic, cross-sectional representation of a fifth variant of an optical fiber according to aspects of the present disclosure;

FIG. 6 is a schematic, cross-sectional representation of a sixth variant of an optical fiber according to aspects of the present disclosure;

FIG. 7 is a schematic, cross-sectional representation of a seventh variant of an optical fiber according to aspects of the present disclosure; and

FIG. 8 is a block diagram that provides a schematic representation of a laser system according to aspects of the present disclosure.

### DETAILED DESCRIPTION

The disclosure relates to an optical fiber having a plurality of light-conducting core regions which extend, mutually spaced, along the longitudinal extension of the optical fiber and which are all located, viewed in the cross-section of the optical fiber, inside a contiguous signal region which, for its part, is completely enclosed by a cladding region, wherein the optical fiber contains stress elements which are designed to generate a mechanical stress field in the optical fiber, wherein each core region is subjected by the stress elements to a mechanical stress causing birefringence and thus polarization-maintaining behavior, wherein one main polarization axis is assigned with each of the core regions. Further, all stress elements are located outside the signal range, whereby the mechanical stress field generated by the arrangement of the stress elements causes the main polarization axes to point in the same direction in all core regions.

When this description refers to the arrangement and/or shape of the various elements of the optical fiber, this always refers to the cross-sectional view of the optical fiber, unless expressly stated otherwise.

The present disclosure proposes an approach to realize a polarization-maintaining multicore fiber, that is an optical fiber with any number and arrangement of light-conducting core regions. An aspect of the present disclosure is that the stress elements are not located between the core regions, but outside the common signal region in which the core regions are located. The signal region is the contiguous area in which all core areas (and also all imaginary connecting lines between neighboring core areas) are located. In other words, the stress elements do not act on individual core areas, but “globally” on the overall arrangement of the core areas. This offers a high degree of flexibility when designing the arrangement and shape of the core areas and minimizes disadvantages in terms of pump absorption.

Each core area of the optical fiber is subjected to a mechanical stress causing birefringence by the stress elements. As mentioned, the overall arrangement of the stress elements outside the signal region acts on all core areas simultaneously. Due to the birefringence, each core area, or the light guide of each core area, exhibits polarization-maintaining behavior. A main polarization axis is assigned to each of the core areas.

For example, the arrangement of the stress elements is not rotationally symmetrical. This means that the arrangement of the stress elements cannot be mapped onto itself for arbitrary rotations around the axis of the optical fiber. For example, the arrangement is therefore not cylindrically symmetrical. Optionally, the stress elements can have an axial symmetry when viewed in the cross-section of the optical fiber. It is important that an optical anisotropy is generated by the distribution of the stress elements across the cross-section of the optical fiber. The stress field should (at least) have a single excellent direction in the entire signal range, that is a main direction of the effective stress, in such a way that the main polarization axes of all core regions point in the same direction.

In other words, the non-uniform arrangement of the stress elements defines the directional distribution of the stress in the stress field over the cross-section of the optical fiber, particularly in the signal region. The stress elements are arranged in such a way that the direction of the maximum stress (main direction of the stress field) and thus the direction of the main polarization axis is (essentially) the same for all core areas.

The stress elements can optionally be arranged in groups across the cross-section of the optical fiber. The distances between the stress elements of a group are smaller than the distances between the stress elements assigned to different groups. Combining several smaller stress elements into a group has the effect that a single larger stress element can be achieved with regard to the generated mechanical stress field. For example, the groups can be arranged on two opposite sides of the signal region, with the connecting line between the groups defining an excellent axis of the generated mechanical stress field and correspondingly specifying the orientation of the optical anisotropy in the channel areas. Each group can also be formed by an arrangement of stress elements lined up along at least one straight line or along at least one arc segment. All these configurations are well suited to achieving a suitable mechanical stress field and thus a well-defined birefringence in the core areas by arranging the groups.

In an embodiment, the stress elements are located in the cladding region. The cladding region encloses the signal region. The stress elements can be appropriately arranged there in order to act directly on the entirety of the core areas. The material of the stress elements can have a lower refractive index than the material of the optical fiber in the cladding region. In this way, the stress elements can fulfill an additional function in guiding pump light in the cladding region. The stress elements can, for example, be distributed over the cross-section of the optical fiber in such a way that they surround the signal region on all sides. In this way, a good overlap of the pump light guided in the cladding region with the core areas and thus a high pump absorption can be achieved.

In an embodiment, the stress elements are located outside the cladding region (which guides the pump light), that is in other areas of the optical fiber that surround the outside of the cladding region. This has the effect that the pump absorption is not impaired at all by the stress elements and that a wider range of materials can be used for the stress elements. The refractive index of the stress elements does not need to be lower than the refractive index of the material (e.g., SiO₂) in the cladding region.

In an embodiment, the signal region is a rectangular area whose center of gravity coincides with the longitudinal center axis of the optical fiber. Alternatively, the signal region can be a circular or annular area whose center of gravity coincides with the longitudinal center axis of the optical fiber. Ultimately, any shape of the signal region and any arrangement of the core areas within it is conceivable. For example, the core areas can be arranged next to and on top of each other as a two-dimensional array (on the intersection points of an imaginary rectangular grid). The core areas can also be arranged on the circumference of a circle. An unordered arrangement of the core areas is also conceivable.

Like the stress elements, the core regions, for example, have a circular cross-section. The circular cross-section makes it easy to manufacture the optical fiber. In the case of the core regions, this, for example, results in a circular (e.g., Gaussian) beam profile of the light propagating along the core regions.

In an embodiment, at least two of the stress elements differ from each other in terms of cross-sectional size. This means that stress elements of different sizes can be used to generate the desired mechanical stress field.

A mechanical stress field can be specifically generated by suitable arrangement and/or size of the stress elements, by means of which a birefringence pattern for a special “exotic” polarization state (e.g., azimuthal or radial polarization) of the guided light is specifically achieved.

The optical fiber according to the disclosure can be used as an optical amplifier or as an active element in a laser resonator. For this purpose, at least one of the core regions is suitably doped with rare earth ions, for example, all core regions.

The disclosure also relates to a laser system having at least one laser source which emits a laser beam, a splitting element which splits the laser beam into at least two spatially separated partial beams, at least one optical fiber of the type described above, through which the partial beams propagate, the core regions of the optical fiber each guiding one of the partial beams, and at least one combining element which coherently superimposes the partial beams after propagation through the optical fiber. With the polarization-maintaining optical fiber of the disclosure, a high-power laser system based on the principle of coherent combination of partial beams can be, for example, realized without the disadvantages known from the prior art with regard to pump absorption.

Examples of embodiments of the present disclosure are explained in more detail below with reference to the drawings.

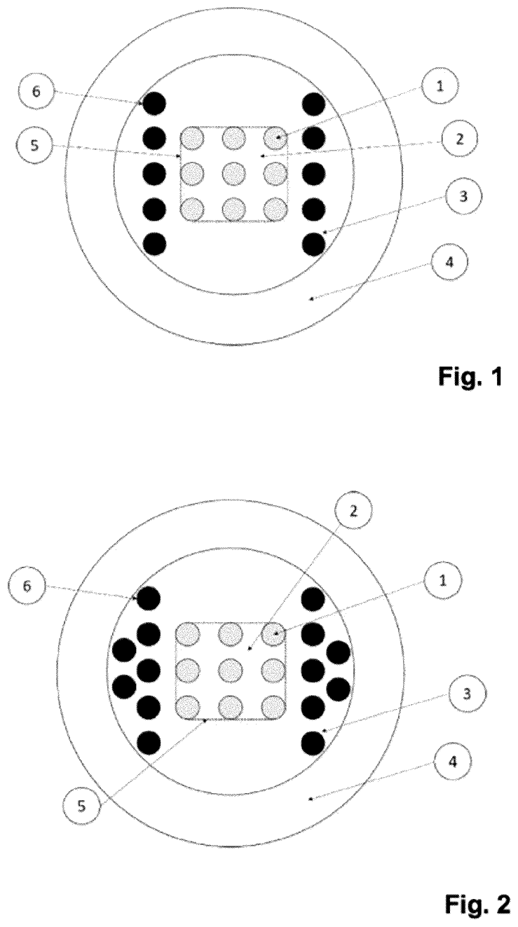

The present disclosure is primarily aimed at optical fibers, for example, multi-core fibers for high-power laser systems. The cross-sectional structure of these multi-core fibers can be divided into different areas, as shown in the figures. With general reference to FIGS. 1-7, several core areas 1 are provided in which the amplification and/or guidance of the light takes place. These are contained in a signal region 2, which is defined as the area that completely encloses all core areas as well as all (imaginary) lines (not shown) that connect the centers of immediately adjacent core areas. In the figures, the signal region 2 is delimited from the other areas by a boundary line 5. For example, the boundary line 5 does not intersect any of the aforementioned (imaginary) lines that connect the centers of immediately adjacent core areas. One could also say that the boundary line 5 is the shortest possible curve that completely surrounds all core areas 2. The core areas 1 can be arranged as desired within the signal region 2. The light guidance can take place with any means (by step index, refractive index gradient, photonic crystals, band gaps, grazing incidence, etc.). In other words, the realization of the optical fiber according to the disclosure is independent of the design of the structures within the signal region 2. The signal region 2 and thus the core regions 1 are located within a cladding region 3. In the case of an active multicore fiber, this is the region in which the pump radiation is guided. Finally, the cladding region 3 can be surrounded by one or more outer layers 4, which can be used, for example, to keep the pump light inside the cladding 3 or to give the fiber mechanical stability.

It should be noted that the material of the multi-core fiber surrounding the core areas 1 within the signal region 2 does not have to differ from the material in the cladding region 3 (outside the stress elements 6). The distinction between signal region 2 and cladding region 3 serves to explain the structure, for example, with regard to the arrangement of the stress elements 6 outside the signal region 2, and not to differentiate between areas of the multicore fiber with different material or structural properties. In terms of light guidance, the core regions 1 can be embedded in the same cladding material (e.g., SiO₂) of the multicore fiber that the cladding region 3 is also made of.

In order to achieve birefringence and thus polarization-maintaining behavior in the multicore fiber according to aspects of the present disclosure, stress elements 6 are provided which generate a mechanical stress field across the cross-section of the multicore fiber. As can be seen in the figures, the stress elements 6 are never located inside the signal region 2, but outside it. The stress elements 6 are never located on one of the aforementioned (imaginary) lines that connect the centers of the adjacent core areas 1. Thus, the stress elements 6 do not act on individual core areas 1, but on the entire signal region 2. This enables a flexible arrangement of the core areas 1 within the signal region 2. The impairment of the pump absorption in the signal region 2 is correspondingly low.

With reference to FIG. 1, the stress elements 6 are arranged in the same way as the core areas 1. The stress elements 6 have the same size and the same distance from each other as the core areas 1. In other words, the stress elements 6 are arranged in such a way that they continue the matrix-shaped arrangement of the core areas 1. The stress elements 6 are arranged in the cladding region 3.

With reference to FIG. 2, the stress elements 6 have a more complex arrangement, whereby the main parameters of the arrangement of the core regions 1 (i.e., size and spacing) are retained.

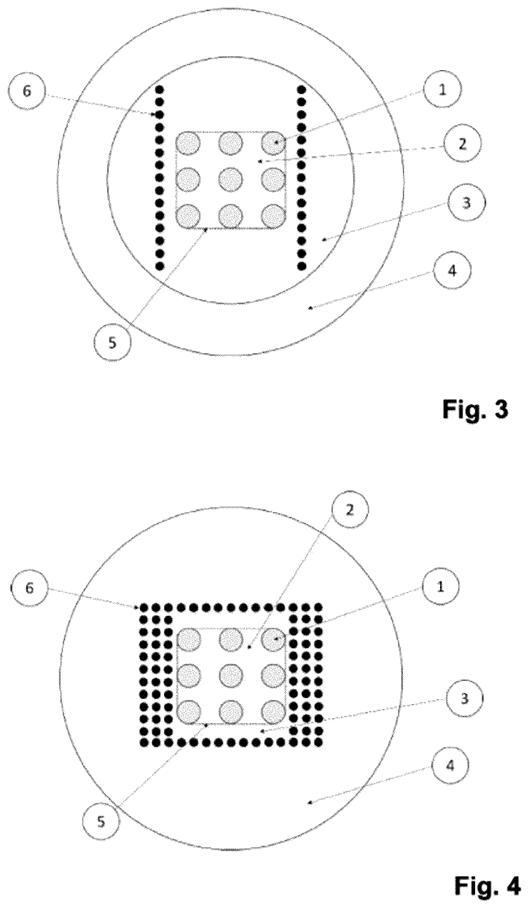

FIG. 3 illustrates that the arrangement of the stress elements 6 does not have to retain the main parameters of the arrangement of the core areas 1, but that they can be freely distributed in the cladding region 3 as long as they are outside the signal region 2, that is not placed within the area delimited by the area boundary 5.

FIG. 4 shows that an asymmetrical arrangement of the stress elements 6, which completely enclose the signal region 2 on all sides, can have a double benefit in that it gives the core areas 1 birefringence and also causes or at least supports the guidance of pump light in the cladding region 3. For this purpose, the stress elements 6 have a lower refractive index than the base material of the multi-core fiber in the cladding region 3. In FIG. 4, the arrangement of the stress elements 6 forms the boundary between the cladding region 3 and the outer layers 4. In FIG. 4, the arrangement of the stress elements 6 does not correspond to the arrangement of the core regions 1, since a denser packing of the stress elements 6 is required in order to guide the pump light with the lowest possible losses.

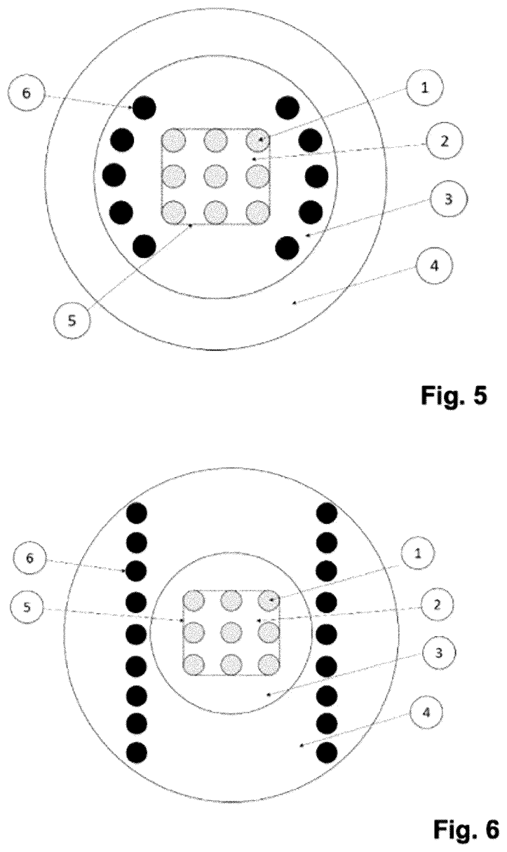

While in FIGS. 1 to 4 the stress elements 6 are lined up along straight lines, corresponding to the arrangement of the core areas 1, a completely different arrangement is provided in FIG. 5. In FIG. 5, the stress elements 6 are lined up along two circular segments lying opposite each other in relation to the center of the multi-core fiber. This allows the homogeneity of the birefringence in the signal region 2 to be improved.

As shown in FIG. 6, the stress elements 6 can also be arranged completely outside the cladding region 3. In this case, they can follow the arrangement parameters of the core areas 1. However, the latter is not absolutely necessary.

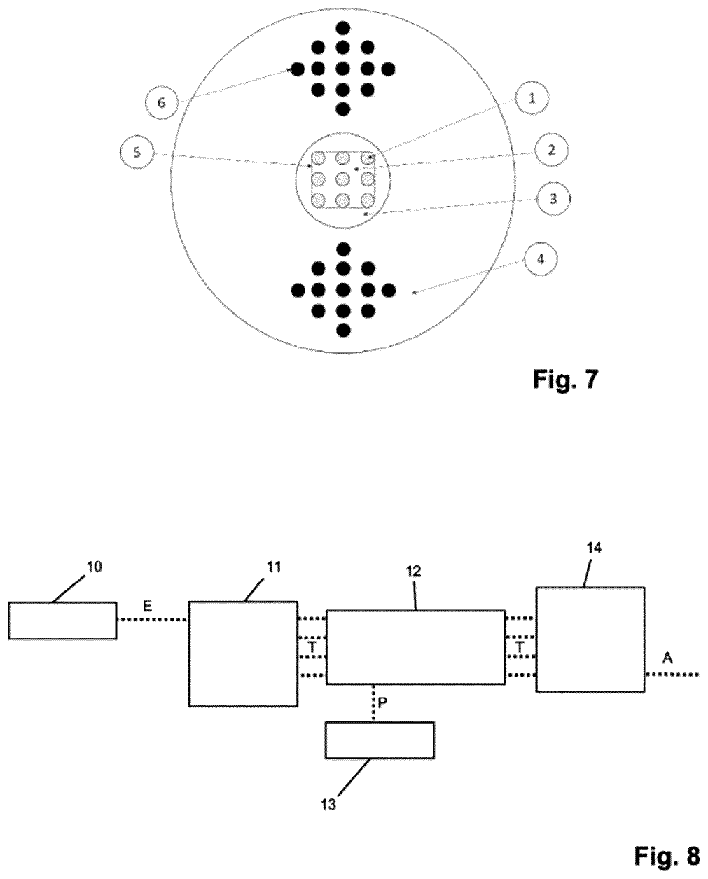

Utilizing the additive property of the stress fields, the stress elements 6 can be arranged in groups to simulate the mechanical stress generated by a single larger stress element 6, as shown in FIG. 7.

In the embodiments of FIGS. 1 to 7, the stress elements 6 are not arranged rotationally symmetrically with respect to the center of the cross-section, that is the central axis of the optical fiber. The arrangement of the stress elements 6 defines an excellent axis of the stress field generated in the signal region 2. In this way, it can be achieved that the main polarization axes in all core areas 1 are aligned in the same direction, that is with a maximum deviation of the main polarization axis from core to core of ±10°, for example, ±5°.

In FIGS. 1 to 7, the arrangement of the stress elements 6, seen in the cross-section shown in each case, is axially symmetrical with respect to at least one axis. In FIGS. 1 to 7, there are two mutually perpendicular (here horizontal and vertical) axes of symmetry, each of which runs through the center of the cross-section (where the central axis of the optical fiber is located). As can be seen, the stress elements are further away from this axis of symmetry in the direction perpendicular to the one axis of symmetry (in FIGS. 1 to 6 in the horizontal direction, in FIG. 7 in the vertical direction) than in the direction again perpendicular to it (in FIGS. 1 to 6 in the vertical direction, in FIG. 7 in the horizontal direction). In each case, a preferred direction of the maximum stress, that is an optical anisotropy in the entire signal region 2, is defined, which results in the desired same orientation of the main polarization axis for all core regions 1.

It should be noted that the cross-sectional structures shown in FIGS. 1 to 7 and also otherwise explained in this description continue essentially invariably along the longitudinal extent of the optical fiber or multi-core fiber.

The laser system shown in FIG. 8 comprises a laser source 10 that generates a laser beam E. This is fed to a splitting element 11, which splits the laser beam E into several spatially separate partial beams T. It is also conceivable that the laser source 10 already generates several laser beams. These partial beams T propagate through an optical fiber 12, which is designed as a multi-core fiber as shown in FIGS. 1 to 7. Each core area 1 of the optical fiber carries a partial beam T. The light P from a pump light source 13 is coupled into the cladding region 3 of the optical fiber 12 so that it can be absorbed in the core areas 1. Hereby the laser beam is amplified in each partial beam T. Furthermore, a combination element 14 is provided which coherently or incoherently superimposes the amplified partial beams T in an output beam A. In this way, a high-power laser system can be realized with the optical fiber 12 according to aspects of the present disclosure.

The disclosure provides an improved multi-core optical fiber with polarization-maintaining properties.

1. An optical fiber comprising:
a cladding region;
a contiguous signal region enclosed by the cladding region;
a plurality of light-conducting core regions that extend, mutually spaced, along a longitudinal extension of the optical fiber, wherein the plurality of light-conducting core regions are all located inside the contiguous signal region in a cross-sectional view of the optical fiber; and
a plurality of stress elements located outside the contiguous signal region in the cross-sectional view of the optical fiber, the plurality of stress elements configured to generate a mechanical stress field in the optical fiber, wherein each core region of the plurality of light-conducting core regions is subjected by the plurality of stress elements to a mechanical stress causing birefringence and thus polarization-maintaining behavior, wherein one main polarization axis is assigned with each core region of the plurality of light-conducting core regions
and, wherein the mechanical stress field generated by an arrangement of the plurality of stress elements causes the main polarization axes to point in the same direction in all core regions.

2. The optical fiber according to claim 1, wherein the plurality of stress elements are each located in the cladding region.

3. The optical fiber according to claim 2, wherein the material of the plurality of stress elements has a lower refractive index than the material of the optical fiber in the cladding region.

4. The optical fiber according to claim 1, wherein the plurality of stress elements are located outside the cladding region.

5. The optical fiber according to claim 1, wherein the contiguous signal region, cross-sectional view of the optical fiber, is a rectangular region whose center of area coincides with the longitudinal center axis of the optical fiber.

6. The optical fiber according to claim 1, wherein the contiguous signal region in the cross-sectional view of the optical fiber, is a circular or annular region whose center of area coincides with the longitudinal center axis of the optical fiber.

7. The optical fiber according to claim 1, wherein the plurality of stress elements are arranged in groups of two or more stress elements each, the groups distributed over the cross-sectional view of the optical fiber.

8. The optical fiber according to claim 7, wherein the groups are arranged on two opposite sides of the contiguous signal region.

9. The optical fiber according to claim 7, wherein each group is formed by an arrangement of stress elements lined up along at least one straight line.

10. The optical fiber according to claim 7, wherein each group is formed by an arrangement of stress elements lined up along at least one arc segment.

11. The optical fiber according to claim 1, wherein the plurality of stress elements each have a circular cross-section.

12. The optical fiber according to claim 1, wherein the plurality of stress elements are distributed over the cross-sectional view of the optical fiber such that they surround the contiguous signal region on all sides.

13. The optical fiber according to claim 1, wherein at least two stress elements of the plurality of stress elements differ from each other with respect to cross-sectional size.

14. The optical fiber according to claim 1, wherein at least one core region of the plurality of core regions is doped with rare earth ions.

15. A laser system comprising:
a laser source to emit a laser beam;
a splitting element to split the laser beam into at least two spatially separated partial beams;
at least one optical fiber according to claim 1, through which the partial beams propagate, the optical fiber including a plurality of light-conducting core regions that are each to guide one of the partial beams; and
at least one combination element to superimpose the partial beams coherently or incoherently after propagation through the optical fiber.
